(19) United States
(12) Patent Application Publication
(10) Pub. No.: US 2011/0157930 A1
(43) Pub. Date: Jun. 30, 2011

(54) POWER INPUT STABILIZING CIRCUIT

(76) Inventors: Hui-Ming WU, Taipei (TW); Chung-Yang WU, Taipei (TW)

(21) Appl. No.: 12/650,559

(22) Filed: Dec. 31, 2009

(51) Int. Cl. H02H 7/125

(52) U.S. Cl. 363/53

(57) ABSTRACT

The power input stabilizing circuit provides a first resistor at the input terminals to suppress impulse current. Then, the power passes through a power input limiting circuit including a non-polarity capacitor, a rectifier circuit formed by diodes, and a polarity capacitor so as to provide a current within a specific range to a load. A constant current circuit including a third resistor, a diode, a fourth resistor, and a transistor is then employed to stabilize the load current. The performance and durability of the electrical or electronic appliance using the power input stabilizing circuit are therefore enhanced significantly.

### TECHNICAL FIELD OF THE INVENTION

The present invention generally relates to a power input stabilizing circuit, and especially relates to a power input stabilizing circuit capable of suppressing impulse current and stabilizing load current.

### DESCRIPTION OF THE PRIOR ART

As electrical and electronic appliances are continuously driven to be even more compact and highly efficient, heat dissipation and power supply have become major design issues to the durability of these appliances. Conventionally, input power to the appliances undergoes voltage drop through parallel-connected discharge resistors and capacitors, rectification through diodes, and finally becomes applicable to a load of the appliance through a current limiting circuit. This approach avoids the use of a bulky transformer and effectively controls current/voltage within a specific range. However, it is still susceptible to spikes or current impulses when the appliance is turned on or off. These impulses usually would mistakenly trigger electronic components and compromise the durability of the highly compact and delicate electronic components.

### SUMMARY OF THE INVENTION

Therefore, a novel power input stabilizing circuit is provided that is applicable to various electrical and electronic appliances to overcome the aforementioned drawbacks of prior art.

To sustain the spikes and current impulses resulted from power on/off or induced by thunder lighting, the present invention provides a first resistor at the input terminals to suppress impulse current. Then, the power passes through a power input limiting circuit including a non-polarity capacitor, a rectifier circuit formed by diodes, and a polarity capacitor so as to provide a current within a specific range to a load. A constant current circuit is then employed to stabilize the load current. As described, the present invention suppresses impulse current and stabilizes the load current through the power input limiting circuit and the constant current circuit. The performance and durability of the electrical or electronic appliance using the power input stabilizing circuit are therefore enhanced significantly.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram showing the functional blocks of the power input stabilizing circuit according to the present invention.

FIG. 2 is a schematic diagram showing an embodiment of the power input stabilizing circuit according to the present invention.

FIG. 3 is a schematic diagram showing another embodiment of the power input stabilizing circuit according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

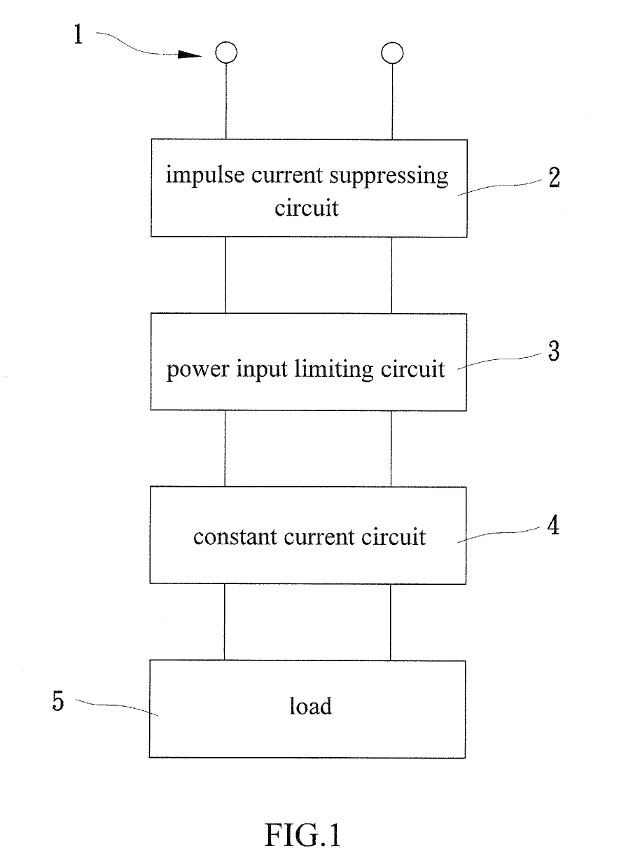

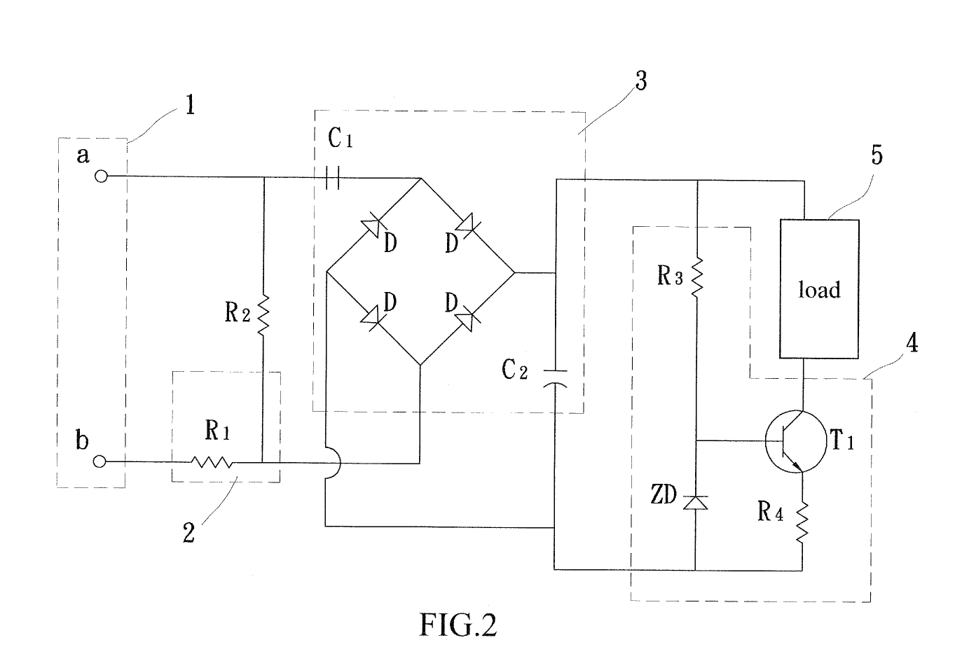

As shown in FIGS. 1 and 2, a power input stabilizing circuit according to an embodiment of the present invention mainly contains an impulse current suppressing circuit 2, a power input limiting circuit 3, and a constant current circuit 4.

As illustrated, power is introduced through power input terminals 1, and then passes through a first resistor R1 of the impulse current suppressing circuit 2. The power input limiting circuit 3 contains a non-polarity capacitor C1 and a rectifier circuit formed by 4 diodes D and a polarity capacitor C2. The constant current circuit 4 contains a third resistor R3, a diode ZD, a fourth resistor R4, and a transistor T1 to interface with a load 5.

As shown in FIG. 2, the external AC power is input from the power input terminals 1 and impulse current is suppressed by the first resistor R1 of the impulse current suppressing circuit 2. Then, the AC power is rectified through the non-polarity capacitor C1, the rectifier circuit, and the polarity capacitor C2. And, finally, the third resistor R3, the diode ZD, the fourth resistor R4, and the transistor T1 provide current to the load 5. In an alternative embodiment, the fourth resistor R4 is replaced by a variable resistor. The power input stabilizing circuit provided by the present invention, in addition to the suppression of the impulse current, could also adjust the load current by changing the capacitance of the non-polarity capacitor C1. Assuming that the current through load 5 is Ic, the peak voltage difference is Vm, then

Ic=2(Vm)C1/T.

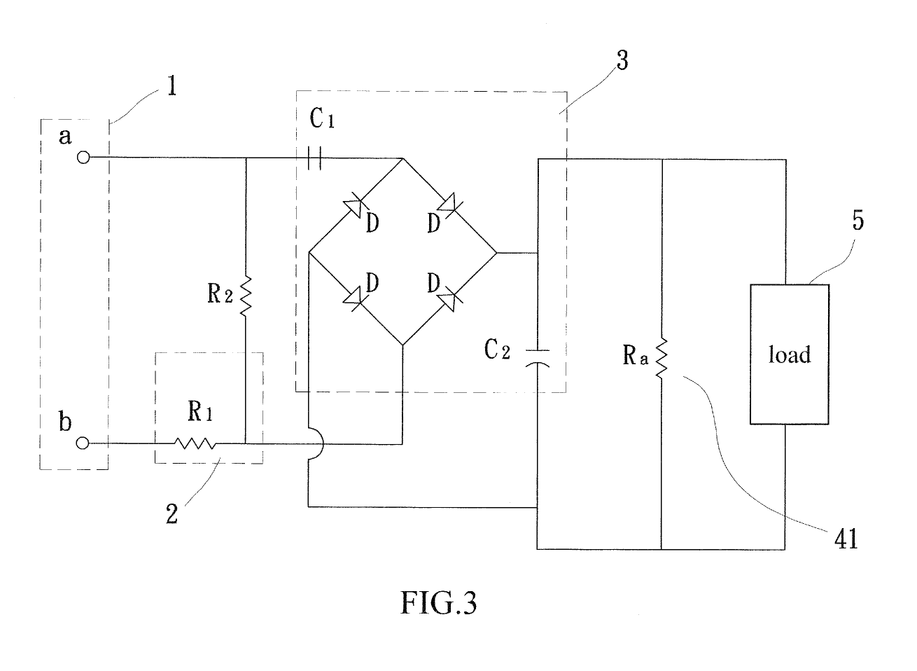

Therefore, by increasing the capacitance of the non-polarity capacitor C1, the current Ic through load 5 would be increased as well. As such, depending on the current required by the load 5, the circuit could be designed so that the load current is controlled within a specific range. Then, by the constant current circuit 4, the current through the load 5 is stabilized so as to enhance the performance and durability of the electrical or electronic appliance. In addition, when the external power is shut down, some residual charge may still be present in the polarity capacitor C2 and could be hazardous if touched by some people. Therefore, as shown in FIG. 3, the constant current circuit 4 could be replaced by a discharging resistor 41 so as to release the charge accumulated on the polarity capacitor C2.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power input stabilizing circuit, comprising:
an impulse current suppressing circuit having a first resistor for the suppression of impulse current;
a power input limiting circuit formed by a non-polarity capacitor, a plurality of diodes, and a polarity capacitor; and
a constant current circuit formed by a third resistor, a diode, a fourth resistor, and a transistor, providing a load current to a load.

2. The power input stabilizing circuit according to claim 1, wherein said load current is proportional to the capacitance of said non-polarity capacitor.

3. The power input stabilizing circuit according to claim 1, wherein said fourth resistor of said constant current circuit is a variable resistor.

4. The power input stabilizing circuit according to claim 1, wherein said constant current circuit is replaced by a discharging resistor to discharge said polarity capacitor.
